(19) United States
(12) Patent Application Publication
(10) Pub. No.: US 2025/0117579 A1
(43) Pub. Date: Apr. 10, 2025

(54) GENERATED AUTOMATED AGENT INSTRUCTIONS FROM USER TRAINING MATERIALS

(71) Applicant: Scaled Cognition, Inc., Amesbury, MA (US)

(72) Inventors: Adam Pauls, Berkeley, CA (US); Mathew Gardner, Irvine, CA (US); Emmanoiul Anthony Platanios, Fremont, CA (US); Mitchell Stern, Berkeley, CA (US); Daniel Klein, Berkeley, CA (US); Marco DiPlacido, Cambridge, MA (US)

(73) Assignee: Scaled Cognition, Inc., Amesbury, MA (US)

(21) Appl. No.: 18/388,532

(22) Filed: Nov. 10, 2023

Related U.S. Application Data
(60) Provisional application No. 63/542,375, filed on Oct. 4, 2023.

(51) Int. Cl. G06F 40/274; G06F 16/34; G06F 40/40

(52) U.S. Cl. CPC G06F 40/274; G06F 16/345; G06F 40/40

(57) ABSTRACT

A system for generating instructions based on part from human training materials, wherein the generated instructions are used to train automated agents. The training materials may include training manuals, knowledge-base documents, articles, and other content. The training materials are processed and converted to a format that is digestible by a machine learning model. The processed training materials can be submitted as a prompt, along with role information and prompt instruction information. The prompt instructions provided with the role and training materials may direct the machine learning model to find relevant generated instructions from the provided training materials. The machine learning model processes the prompt and outputs extracted instructions from the content. The instruction document may be stored in a vector database for later use.

### CROSS REFERENCE TO RELATED APPLICATIONS

The present application claims the priority benefit of U.S. provisional patent application 63/542,375, filed on Oct. 4, 2023, titled “Creating Automated Agent Instructions from User Training Materials,” the disclosure of which is incorporated herein by reference.

### BACKGROUND

As online applications continue to develop, automated assistant applications are becoming more popular. To develop an online assistant, the software implementing the system is usually trained. Typically, training materials are generated manually for automated assistant software. This includes manually generating specialized training examples, in some cases hundreds or thousands of examples. This takes considerable time, and specialized knowledge by an individual as to what the automated agent is supposed to achieve. This results in a very inefficient process for generating training materials for an automated agent. What is needed is an improved way of developing an automated assistant.

### SUMMARY

The present technology, roughly described, provides a system for creating instructions for an automated agent from training materials. The training materials may include training manuals, knowledge-based documents, articles, troubleshooting guides, content of discussion forms, messaging and chat applications, video recordings and transcriptions, incident reports, and other content. The training materials are processed to be placed in a format that can be digested by a machine learning model.

In some instances, the machine learning (ML) model may be implemented as a large language model (LLM). The processed training materials are submitted within a prompt, along with role information and instruction information. The role included in the prompt may indicate the role that the automated agent will have when following the instructions extracted from the training materials, which are output by the machine learning model. The instructions included in the prompt may direct the machine learning model to find relevant instructions from the provided learning materials.

The machine learning model processes the prompt and generates extracted instructions based on the prompt content. In some instances, the training material content may be submitted in chunks using several prompts, for example due to size limitations in the prompt. After outputting extracted instructions, the instructions may be summarized and placed into an instruction document. The instruction document may be stored in a vector database or other search index for later use.

In some instances, the present technology performs a method for creating automated agent instructions from training materials. The method begins with accessing a plurality of training materials having at least two different formats. A first training material of the plurality of training materials can be processed to convert the first training material into a form suitable for processing by a machine learning model. The system can then provide a prompt to the machine learning model, the prompt specifying a role, at least one of the plurality of training materials, and prompt instructions to the machine learning model to generate instructions from the at least one of the training materials. The system then receives an output from the machine learning model in response to the prompt, wherein the output includes a set of generated instructions derived from the training materials contained in the prompt. The system can then store the set of generated instructions output by the machine learning model in a vector database.

In some instances, the present technology includes a non-transitory computer readable storage medium having embodied thereon a program, the program being executable by a processor to creating automated agent instructions from training materials. The method begins with accessing a plurality of training materials having at least two different formats. A first training material of the plurality of training materials can be processed to convert the first training material into a form suitable for processing by a machine learning model. The system can then provide a prompt to the machine learning model, the prompt specifying a role, at least one of the plurality of training materials, and prompt instructions to the machine learning model to generate instructions from the at least one of the training materials. The system then receives an output from the machine learning model in response to the prompt, wherein the output includes a set of generated instructions derived from the training materials contained in the prompt. The system can then store the set of generated instructions output by the machine learning model in a vector database.

In some instances, the present technology includes a system having one or more servers, each including memory and a processor. One or more modules are stored in the memory and executed by one or more of the processors to access a plurality of training materials having at least two different formats, process a first training material of the plurality of training materials to convert the first training material into a form suitable for processing by a machine learning model, provide a prompt to the machine learning model, the prompt specifying a role, at least one of the plurality of training materials, and prompt instructions to the machine learning model to generate instructions from the at least one of the training materials, receive an output from the machine learning model in response to the prompt, the output including a set of generated instructions derived from the training materials contained in the prompt, and store the set of generated instructions output by the machine learning model in a vector database.

### BRIEF DESCRIPTION OF FIGURES

FIG. 1 is a block diagram of a system for creating chat application instructions from user training materials.

FIG. 2 is a block diagram of a processing system.

FIG. 3 is a block diagram of a prompt.

FIG. 4 is a block diagram of a machine learning model.

FIG. 5 is a block diagram of an application.

FIG. 6 is a method for creating chat application instructions from user training materials.

FIG. 7 is a method for generating prompt content from information.

FIG. 8 is a method for generating a prompt for a large language model.

FIG. 9 is a block diagram of a computing environment for implementing the present technology.

### DETAILED DESCRIPTION

The present technology, roughly described, provides a system for generating instructions for an automated agent from training materials. The training materials may include training manuals, knowledge-based documents, articles, troubleshooting guides, dialog trees, interactive voice response phone trees, content of discussion forms, messaging and chat applications, video recordings and transcriptions, incident reports, and other content. The training materials are processed to be placed in a format that can be digested by a machine learning model.

In some instances, the machine learning (ML) model may be implemented as a large language model (LLM). The processed training materials are submitted within a prompt, along with role information and prompt instruction information. The role may indicate the role of the automated agent that will follow the extracted instructions generated by the machine learning model. The instructions included in the prompt may direct the machine learning model to find relevant instructions from the provided learning materials.

The machine learning model processes the prompt and outputs generated (i.e., extracted) instructions based on the prompt content. In some instances, the training material content may be submitted in chunks using several prompts, for example due to size limitations in the prompt. After outputting generated instructions, the generated instructions may be summarized and placed into an instruction document. The instruction document may be stored in a vector database or other searchable data store for later use.

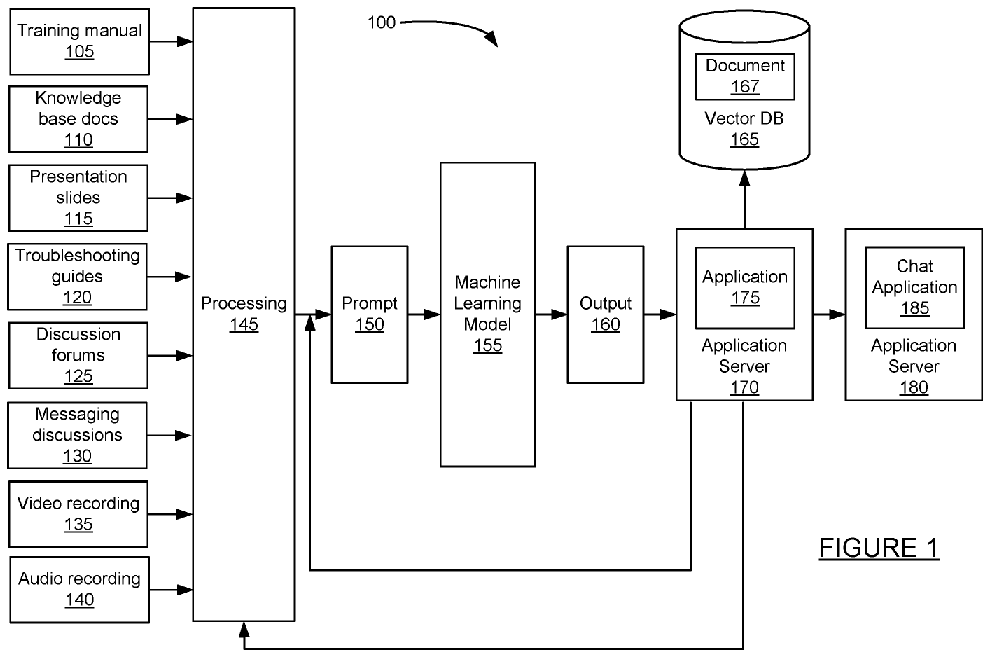

FIG. 1 is a block diagram of a system for creating chat application instructions from user training materials. System 100 of FIG. 1 includes training materials 105-140, processing block 145, machine learning model 155, output 160, application server 170, vector database 165, and application server 180.

Training materials include training manual 105, knowledge-base documents 110, presentation slides 115, troubleshooting guides 120, discussion forums 125, messaging discussions 130, video recordings 135, and audio recordings 140. The training materials may all relate to a service provided by an automated agent. For example, the automated agent may be implemented as a customer service agent for a healthcare company, a travel agent for an airline company, or some other automated assistant that assists users for a particular company, field, or product. Hence, each of the training materials 105-140 may generally relate to the same subject, but have different content.

Training manual 105 may include a manual provided to train human customer service representatives. The training manual may have several pages, chapters, sections, all relating to rules related to performing the job of a customer service representative. In some instances, the training manual, and other training materials, may relate to several different roles, such as a front-line customer service representative, a supervisor, and IT technician, and other roles.

Knowledge-base documents 110 may include documents with information that may assist a user of the service or the customer service representative providing the service. For example, the knowledge-base documents may include wiki pages, frequently asked questions (FAQ), and other documents. Presentation slides 115 may include slides with text, graphics, animations, audio, and other content related at least in part to the job of a customer service agent. Troubleshooting guides 120 may include interactive guides, documents, or other materials that indicate how to handle problems or issues either internally for a customer service representative or how to help users having issues with a service.

Discussion forums 125 may include content found in content pages (e.g., web pages) where users share thoughts on this service provided by the company associated with the customer service representative. Agents of the company can assist or take part in discussions regarding issues related to the service, as well as other points of discussion. Messaging discussions 130 may include conversations associated with a chat application. These discussions may be between users, between a human customer service agent and the customer, between an automated customer service agent and a user, or other messaging discussions.

Video recording 135 may include a help video, demonstration video, or other video related to the service provided by a customer service agent. The video recording may include audio, speech, graphics, text, and other content. Audio recording 140 may be an audio file that captures a conversation between a customer service agent and a user, a customer service agent supervisor and a user, or one or more other parties having a conversation related to the service provided by the customer service agent.

Though several types of training materials are illustrated in FIG. 1, the present technology is not intended to be limited to these materials. The present system may process several types of content, including several not listed, and use any portion of them as part of a prompt for a machine learning model 155.

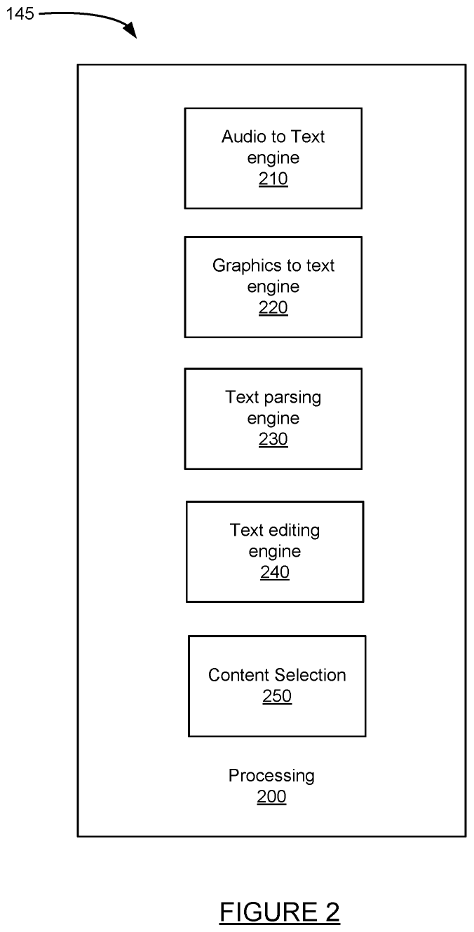

Processing module 145 processes the training materials, if needed, to prepare them for being placed in a prompt 150. For example, training materials may be processed to be placed in a standardized font and size, to remove slang, and to remove sensitive information such as user credit card number, bank account information, and so forth. In some instances, processing module 145 may be used to convert audio speech into text form, such as for example in a video recording or an audio recording. In some instances, processing module 145 may be used to convert graphics into text form, for example graphics that express words in an unconventional format that is not easily converted into text. Processing module 145 is discussed in more detail below the respect to FIG. 2.

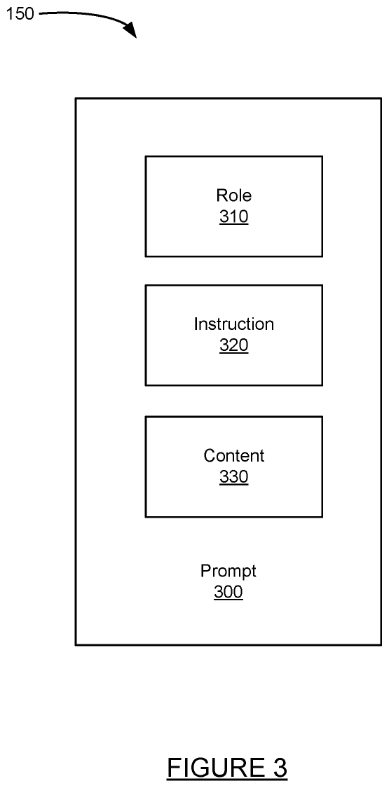

Prompt 150 is generated at least in part from processed training materials and used as an input to machine learning model 155. Prompt 150 may include information identifying a role, prompt instructions relating to what the machine learning model should do, and content. The content is derived from the processed training materials. Prompt 150 is discussed in more detail with respect to FIG. 3.

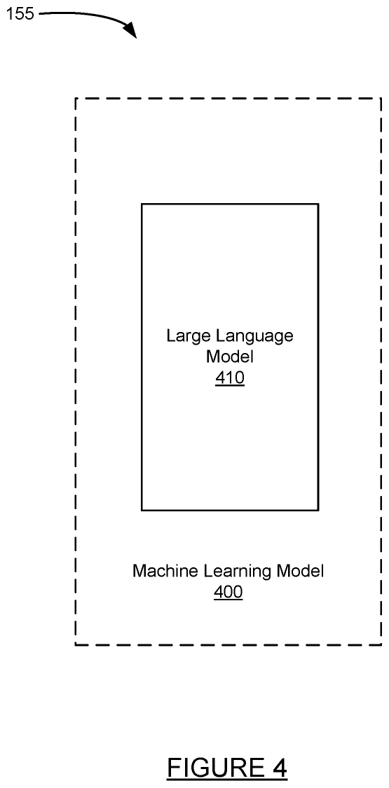

Machine learning model 155 may receive prompt 150, process the prompt, and provide an output 160. In some instances, the prompt can include prompt instructions to identify the most relevant generated instructions—instructions generated from training materials—within the prompt. In response, the machine learning model may process the prompt, identify the most relevant generated instructions, and provide the most relevant generated instructions as output 160. In some instances, machine learning model 155 may be implemented as a large language model. Machine learning model 155 is discussed in more detail with respect to FIG. 4.

Output 160 is provided by machine learning model 155 after processing prompt 150. When the prompt requests the machine learning model to identify the most relevant generated instructions from provided content, the output will include the list of the most relevant generated instructions.

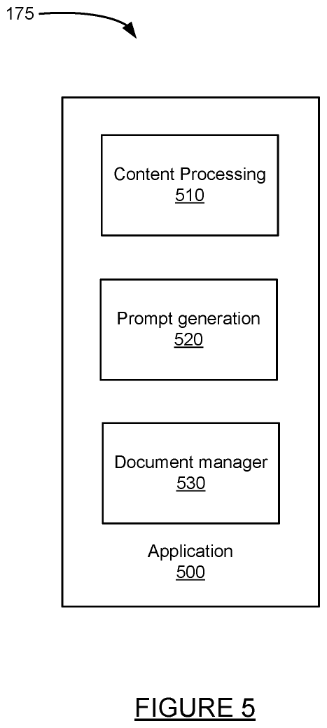

Application server 170 includes application 175 and receives output 160 from machine learning model 155. Upon receiving the output, application 175 may process the output and provide it to vector database 165 (or some other searchable data store). Application 175 may process the output by summarizing the generated instructions provided by machine learning model 155 and placing the summarized instructions into document 167. Document 167 may then be stored at vector database 165. Application 175 is discussed in more detail with respect to FIG. 5.

Vector database 165 may be implemented as a data store that stores vector data. In some instances, vector database 165 may be implemented as more than one data store, internal to application server 170, or external to application server 170. In some instances, a vector database can serve as an LLMs' long-term memory and expand an LLMs' knowledge. Vector database 165 can store private data or domain-specific information outside the LLM as embeddings. When a user asks a question to an administrative assistant, the system can have the vector database search for the top results most relevant to the received question. Then, the results are combined with the original query to create a prompt that provides a comprehensive context for the LLM to generate more accurate answers.

Once instructions for an automated agent are stored in document 167 at vector database 165, a chat application 185 may be implemented on application server 180. The chat application 185 may operate as an automated customer service agent and engage in conversations with users. When a user asks a query, chat application 185 may process a query, at least in part, by initiating a search for instructions from document 167, submission of the instructions to a machine learning model, and then eventually providing a response to the user.

In some instances, machines that implement one or more of 145, 155, 165, 170, and 180 may be implemented within a single system, and may communicate with each other, and other machines, over one or more networks. The networks may include private networks, public networks, a LAN, a WAN, the Internet, an intranet, a wireless network, a Wi-Fi network, a cellular network, a fiber-optic network, a combination of these networks, or some other network that is capable of communicating data. In some instances, one or more of these networks may be implemented within system 103, as well as between system 103 and the machines illustrated outside the system in FIG. 1.

In some instances, one or more of machines 145, 155, 165, 170, and 180 may be implemented in one or more cloud-based service providers, such as for example AWS by Amazon Inc, AZURE by Microsoft, GCP by Google, Inc., Kubernetes, or some other cloud based service provider.

FIG. 2 is a block diagram of a processing system. Processing system 200 may provide more detail for processing block 145 of the system of FIG. 1. Processing system 200 may include audio to text engine 210, graphics attacks engine 220, text parsing engine 230, text editing engine 240, and content selection 250. Audio text engine 210 may convert audio data to text data. The audio data may be received, converted into sounds or phonemes, the phonemes may be grouped into words, and the words may be output as text.

Graphics to text engine 220 may convert graphics into text. For example, graphics having special effects or abnormal text shapes may be detected and converted to text by the engine 220. In some instances, the abnormal shapes may be detected using a border detection algorithm, the shapes may be identified as letters, and the letters may be formed into words.

Text parsing engine 230 may parse text to identify words in a passage. The parsing results may be communicated to text editing engine 240 to edit text as needed. For example, after parsing discussion forum text, text parsing engine 230 may detect several usernames and emails. Text editing engine 240 may then remove the names and emails, or replace the names and emails with generic replacements, rather than include them in content to be included in a prompt.

Content selection 250 may select content provided by processing module 145 and include the content in a prompt 150. In some instances, a training material may have too much content to include in a single prompt. In this case, portions of the train material will have to be selected one at a time to include in a prompt, until all the train material has been included. Content selection 250 may select portions of a train material to include in a prompt, and continue doing so until all of the train material has been submitted to machine learning model 155 in a prompt.

FIG. 3 is a block diagram of a prompt. Prompt 300 of FIG. 3 provides more detail for prompt 150 of the system of FIG. 1. Prompt 300 may include text to provide as input to a machine learning model 155. The text may include information about role 310, prompt instructions 320 for generating an output, and content 330. In some instances, the prompt may include prompt instructions that state the machine learning model is to select the most relevant generated instructions from the content 330 to train a customer service representative having a specified role 310. The content 330 may include processed training materials. The processed training materials may be any of the training materials 105-140 that have been processed, if needed, by the system in FIG. 1. In some instances, the content 330 in a prompt 300 may include only a portion of a particular type of processed training material, to fit within the character or size constraints of the particular machine learning model, and the entire training materials would be submitted in two or more prompts.

A prompt may be in any of several styles, and may be implemented as one or more prompts. For example, a prompt may be implemented as several prompts that are applied to the training materials, each resulting a different set of generated instructions, which can then be combined together. In some instances, for example in ensembling, the generated instructions can be those included in a majority of outputs generated in response to multiple prompts. Examples of a prompt 300 of FIG. 3 for different training materials are below:

For a training manual, “for a customer service representative in a healthcare field, identify the most relevant instructions in this content,” followed by a bulleted list of instructions from a training manual.

For a knowledge document, “for a customer service representative in a healthcare field, identify rules in this material,” followed by a bulleted list of content from the knowledge document.

For a slide deck, “for a customer service representative in a healthcare field, identify rules in this material,” followed by a bulleted list of content from the slide deck.

For a troubleshooting guide, “for a customer service representative in a healthcare field, identify rules in this guide,” followed by a bulleted list of content from the troubleshooting guide.

For a discussion forum, “for a customer service representative in a healthcare field, identify rules from the discussion between the two users,” followed by a bulleted list of content from the discussion forum.

For a chat application conversation, “for a customer service representative in a healthcare field, identify rules that the agent follows based on the following chat with a customer,” followed by a bulleted conversation between an automated agent and a customer.

For a video or audio recording that has been converted to text, “for a customer service representative in a healthcare field, identify rules from the text,” followed by a bulleted list of text from the video or audio recording.

For a video recording having graphics that has been converted to text, “for a customer service representative in a healthcare field, identify rules from the text,” followed by a bulleted list of text from the video.

FIG. 4 is a block diagram of a machine learning model. The machine learning model 400 of FIG. 4 provides more detail for machine learning model 155 of the system of FIG. 1. The machine learning model 400 may be implemented by a large language model 410. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows it to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data. The prompt can include a context (e.g., a role, such as ‘you are an agent’), a bulleted list of itemized instructions, and content to apply the instructions to.

In some instances, the present technology may use an LLM such as a BERT LLM, Falcon 40B on GitHub, Galactica by Meta, GPT-4 by OpenAI, or other LLM. In some instances, machine learning model 155 may be implemented by one or more other models or neural networks.

FIG. 5 is a block diagram of an application. Application 500 of FIG. 5 provides more detail for application 175 of FIG. 1. Application 500 includes content processing 510, prompt generation 520, and document manager 530. Content processing 510 may perform audio to text conversion, graphics to text conversion, text parsing, text editing, and can select content for inclusion into prompt 150. In some instances, content processing 510 may perform at least some or all of the same functions as processing 145.

Prompt generation 520 may generate a prompt as input to machine learning model 155. The prompt may include role information, instructions, and content based on processed training materials. In some instances, the training materials may be provided to application 175, or accessed by application 175, put in the form of a prompt, and then provided to machine learning model 155.

Document manager 530 may generate document 167, which is stored in vector database 165. Document manager 530 may receive outputs from machine learning model 155, summarize the instructions within the outputs, store the outputs in a document, and store document 167 within the vector database 165.

The modules illustrated in application 500 are exemplary and can be implemented in more or fewer modules than those illustrated in FIG. 5. Additionally, application 500 can implement other functionality described herein.

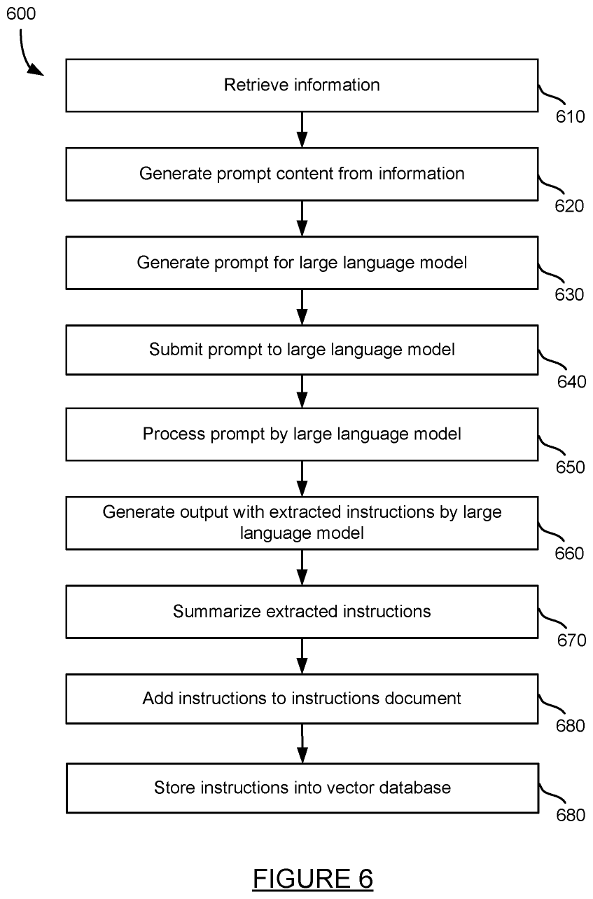

FIG. 6 is a method for generating automated agent instructions from user training materials. First, information may be retrieved at step 610. The retrieved information may include training materials from which instructions may be extracted by machine learning model 155. The training materials may include materials 105-140 in the system of FIG. 1, as well as other materials.

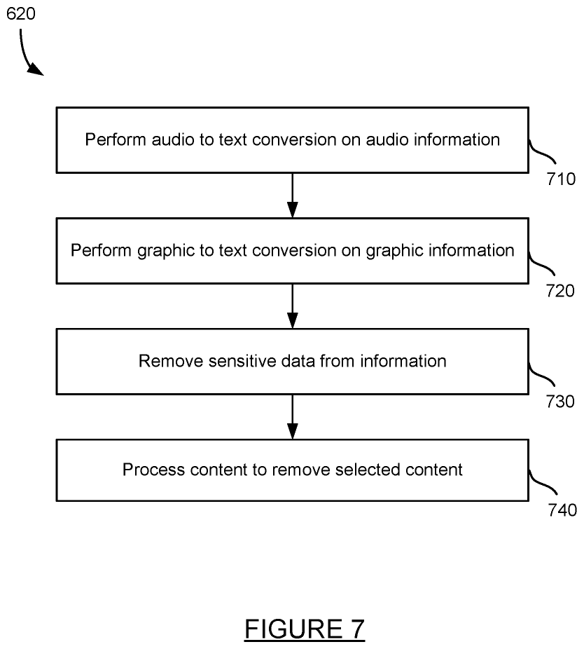

Prompt content may be generated from the information at step 620. In some instances, some of the training materials may need to be processed before they can be submitted in a prompt to machine learning model 155. For example, audio may need to be converted into text, graphics may need to be converted into text, sensitive information may need to be removed, and other processing may be performed. More details for generating prompt content from information such as training materials is discussed with respect to the method of FIG. 7.

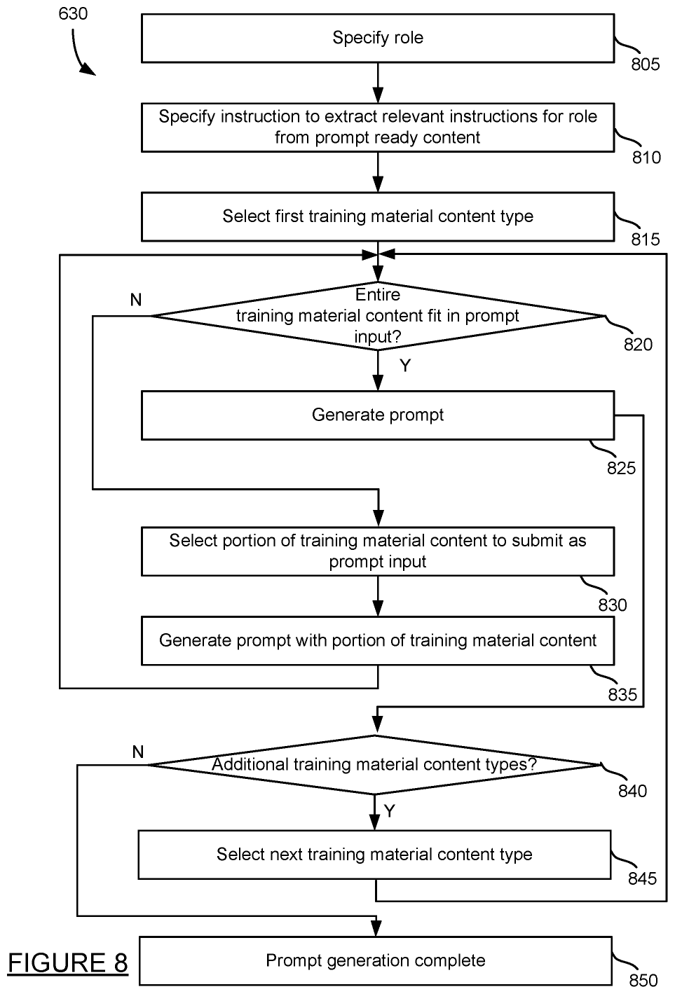

A prompt is generated for a large language model at step 630. The prompt may be generated with a role, prompt instructions for the LLM, and content that includes processed training materials. More details for generating prompts for LLMs are discussed with respect to the method of FIG. 8. The prompt may be submitted to an LLM at step 640. With respect to FIG. 1, prompt 150 may be submitted to machine learning model 155, which may be implemented by a large language model. In some instances, ML model 155 of FIG. 1 may be implemented with a machine learning model other than a large language model. The prompt is processed by the large language model at step 650, and an output is generated with generated instructions by the large language model at step 660.

The generated instructions are summarized at step 670. In some instances, there may be duplicate instructions, the generated instructions may be made more concise, or other changes may be made to the generated instructions. For example, the generated instructions may be checked for grammar, conciseness, and other processing that may be used to generate a clearer instruction. The summarized instructions are then added to an instructions document at step 680. The instructions document may then be stored into a vector database at step 680.

FIG. 7 is a method for generating prompt content. The method of FIG. 7 provides more detail for step 620 of the method of FIG. 6. First, audio to text conversion may be performed on audio information at step 710. In some instances, an audio to text conversion may be performed on video recordings or audio recordings. The resulting text may then be included within a prompt.

Graphic to text conversion may be performed on graphic information at step 720. The graphic to text conversion may be performed on presentation slides, knowledge base documents, troubleshooting guides, and other content that includes graphics which implement text.

Sensitive data may be removed from the information at step 730. In some instances, some training materials may include sensitive information such as full names, emails, phone numbers, or other data that is considered private or confidential. The sensitive data may be removed or replaced with default data.

Content may be processed to remove selected content at step 740. Content may be removed for any of several reasons. In some instances, the content may be recognized to not include any relevant information, such as for example a title page on a presentation slide. In some instances, page numbers from a training manual or timestamps from a video recording may be removed as being irrelevant.

FIG. 8 is a method for generating a prompt for a large language model. The method of FIG. 8 provides more detail for step 630 of the method of FIG. 3. First, a role is specified at step 810. The role may be a customer service agent, or some other role for which instructions or rules may be extracted from the training materials. In particular, the role is specified so that generated instructions for other roles are not selected by the machine learning model, such as supervisory roles, or other roles not related to the service provided by the desired role.

Prompt instructions are specified to extract the relevant generated instructions for the role from the prompt ready content (e.g., processed training materials) at step 810. The prompt instructions may direct the machine learning model to identify the most relevant generated instructions, determine rules based on a conversation, identify instructions or rules based on troubleshooting guides, and other instructions relevant to a role and targeted towards the relevant training material to be included in the prompt.

A first prompt content type is selected at step 815. In some instances, the content type may be any of the process training materials generated from train materials 105-140 (e.g., training manual, knowledge-base documents, presentation slides, and so forth). A determination is made as to whether the entire prompt content may fit into a prompt input at step 820. In some instances, an LLM may have a limit as to the number of characters or lines of text that may be included in a prompt. If the role, instructions, and entire processed training material content (e.g., an entire training manual, entire chat, entire FAQ, entire text from a video or audio file) can fit into a prompt input, the prompt is generated at step 825. If the entire prompt cannot fit into a prompt input, a portion of the training material content is selected to be included in the prompt input that allows a prompt input to be received by the LLM.

The prompt is then generated with a portion of the entire process training material content at step 835. The method then returns to step 820 where a determination is made as to whether the entire remaining training material content can fit into a prompt input at step 820. If the remaining training material content fits into the prompt input with the specified role and instructions, that prompt is generated at step 825, and the method continues to step 840. If the remaining training material content will not fit into the prompt input, a portion of the training material content is selected for inclusion into the prompt at step 830, and a prompt is generated with that portion of the training material content at step 835. The method then continues to step 820 where the process repeats until all of the training material content for the current type of content has been placed into one or more prompts.

A determination is made as to whether there are additional prompt content types at step 840. The additional prompt content types include additional training material contents types, such as any of the types 105-140 in the system of FIG. 1. If there are additional training material content types at step 840, the next training material content type is selected at step 845, and the method returns to step 820 to generate prompts based on the selected content type. If there are no other content types, the prompt generation is complete at step 850.

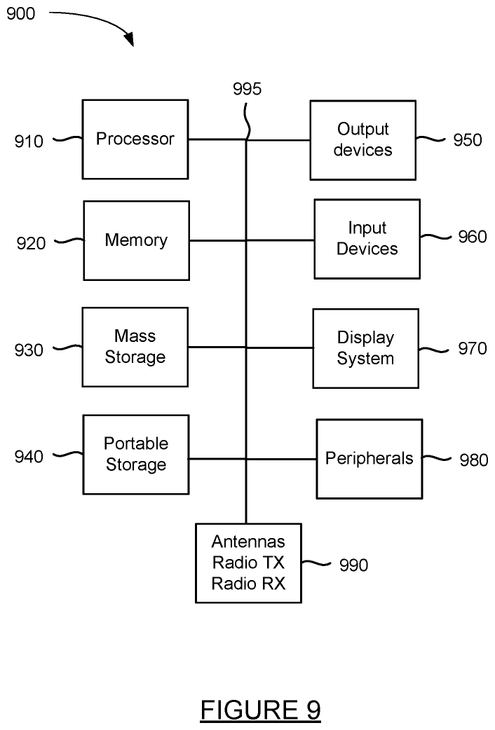

FIG. 9 is a block diagram of a computing environment for implementing the present technology. System 900 of FIG. 9 may be implemented in the contexts of the likes of machines that implement processing 145, machine learning model 155, application server 170, vector database 165, and application server 180. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 995. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive, an optical disk drive, a flash drive, or other device, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable non-volatile storage medium, such as a floppy disk, compact disk or Digital video disc, USB drive, memory card or stick, or other portable or removable memory, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information and processes the information for output to the display device. Display system 970 may also receive input as a touch-screen.

Peripherals 980 may include any type of computer support device to add additional functionality to the computer system. For example, peripheral device(s) 980 may include a modem or a router, printer, and other device.

The system of 900 may also include, in some implementations, antennas, radio transmitters and radio receivers 990. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, iOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for creating automated agent instructions from training materials, comprising:
accessing a plurality of training materials having at least two different formats;
processing a first training material of the plurality of training materials to convert the first training material into a form suitable for processing by a machine learning model;
providing a prompt to the machine learning model, the prompt specifying a role, at least one of the plurality of training materials, and prompt instructions to the machine learning model to generate instructions from the at least one of the training materials;
receiving an output from the machine learning model in response to the prompt, the output including a set of generated instructions derived from the training materials contained in the prompt; and
storing the set of generated instructions output by the machine learning model in a vector database.

2. The method of claim 1, wherein the machine learning model includes a large language model.

3. The method of claim 1, wherein processing the at least one of the plurality of training materials includes at least one of converting audio to text, converting graphics to text, and removing sensitive information.

4. The method of claim 1, wherein providing a prompt includes:
providing a first prompt to the machine learning model, the first prompt including a first portion of the first training material, the role, and the prompt instructions to the machine learning model; and
providing a second prompt to the machine learning model, the second prompt including a second portion of the first training material, the role, and the prompt instructions to the machine learning model.

5. The method of claim 1, wherein providing a prompt includes:
providing a first prompt to the machine learning model, the first prompt including at least a first portion of the first training material, the role, and the prompt instructions to the machine learning model; and
providing a second prompt to the machine learning model, the second prompt including at least a first portion of a second training material, the role, and the prompt instructions to the machine learning model.

6. The method of claim 1, wherein the training materials include at least two of a training manual, knowledge base documents, presentation slides, troubleshooting guides, discussion forums, messaging discussions, and texts from a video file or audio file.

7. The method of claim 1, further comprising summarizing the output of the machine learning model for each type of training material.

8. The method of claim 1, wherein the set of generated instructions is stored in a document in the vector database, the document including instructions generated by the machine learning model from at least two different formats of training materials.

9. A non-transitory computer readable storage medium having embodied thereon a program, the program being executable by a processor to perform a method for creating automated agent instructions from training materials, the method comprising:
accessing a plurality of training materials having at least two different formats;
processing a first training material of the plurality of training materials to convert the first training material into a form suitable for processing by a machine learning model;
providing a prompt to the machine learning model, the prompt specifying a role, at least one of the plurality of training materials, and prompt instructions to the machine learning model to generate instructions from the at least one of the training materials;
receiving an output from the machine learning model in response to the prompt, the output including a set of generated instructions derived from the training materials contained in the prompt; and
storing the set of generated instructions output by the machine learning model in a vector database.

10. The non-transitory computer readable storage medium of claim 9, wherein the machine learning model includes a large language model.

11. The non-transitory computer readable storage medium of claim 9, wherein processing the at least one of the plurality of training materials includes at least one of converting audio to text, converting graphics to text, and removing sensitive information.

12. The non-transitory computer readable storage medium of claim 9, wherein providing a prompt includes:
providing a first prompt to the machine learning model, the first prompt including a first portion of the first training material, the role, and the prompt instructions to the machine learning model; and
providing a second prompt to the machine learning model, the second prompt including a second portion of the first training material, the role, and the prompt instructions to the machine learning model.

13. The non-transitory computer readable storage medium of claim 9, wherein providing a prompt includes:
providing a first prompt to the machine learning model, the first prompt including at least a first portion of the first training material, the role, and the prompt instructions to the machine learning model; and
providing a second prompt to the machine learning model, the second prompt including at least a first portion of a second training material, the role, and the prompt instructions to the machine learning model.

14. The non-transitory computer readable storage medium of claim 9, wherein the training materials include at least two of a training manual, knowledge base documents, presentation slides, troubleshooting guides, discussion forums, messaging discussions, and texts from a video file or audio file.

15. The non-transitory computer readable storage medium of claim 9, further comprising summarizing the output of the machine learning model for each type of training material.

16. The non-transitory computer readable storage medium of claim 9, wherein the set of generated instructions is stored in a document in the vector database, the document including instructions generated by the machine learning model from at least two different formats of training materials.

17. A system for creating automated agent instructions from training materials, comprising:
one or more servers, wherein each server includes a memory and a processor; and
one or more modules stored in the memory and executed by at least one of the one or more processors to access a plurality of training materials having at least two different formats, process a first training material of the plurality of training materials to convert the first training material into a form suitable for processing by a machine learning model, provide a prompt to the machine learning model, the prompt specifying a role, at least one of the plurality of training materials, and prompt instructions to the machine learning model to generate instructions from the at least one of the training materials, receive an output from the machine learning model in response to the prompt, the output including a set of generated instructions derived from the training materials contained in the prompt, and store the set of generated instructions output by the machine learning model in a vector database.

18. The system of claim 17, wherein the machine learning model includes a large language model.

19. The system of claim 17, wherein processing the at least one of the plurality of training materials includes at least one of converting audio to text, converting graphics to text, and removing sensitive information.

20. The system of claim 17, wherein providing a prompt includes:
providing a first prompt to the machine learning model, the first prompt including a first portion of the first training material, the role, and the prompt instructions to the machine learning model; and
providing a second prompt to the machine learning model, the second prompt including a second portion of the first training material, the role, and the prompt instructions to the machine learning model.

21. The system of claim 17, wherein providing a prompt includes:
providing a first prompt to the machine learning model, the first prompt including at least a first portion of the first training material, the role, and the prompt instructions to the machine learning model; and
providing a second prompt to the machine learning model, the second prompt including at least a first portion of a second training material, the role, and the prompt instructions to the machine learning model.

22. The system of claim 17, wherein the training materials include at least two of a training manual, knowledge base documents, presentation slides, troubleshooting guides, discussion forums, messaging discussions, and texts from a video file or audio file.

23. The system of claim 17, the modules further executable to summarize the output of the machine learning model for each type of training material.

24. The method of claim 1, wherein the set of generated instructions is stored in a document in the vector database, the document including instructions generated by the machine learning model from at least two different formats of training materials.
